(19) United States
(12) Patent Application Publication
(10) Pub. No.: US 2017/0303662 A1
(43) Pub. Date: Oct. 26, 2017

(54) COSMETIC HAVING IMPREGNATION MEMBER WITH MELTED OUTSIDE

(71) Applicant: AMOREPACIFIC CORPORATION, Seoul (KR)

(72) Inventors: Hae Won Jeong, Seoul (KR); Sangyoung Jung, Seoul (KR)

(21) Appl. No.: 15/490,779

(22) Filed: Apr. 18, 2017

(30) Foreign Application Priority Data
Apr. 22, 2016 (KR) 10-2016-0049473

(51) Int. Cl. A45D 40/22; B65D 43/16; B29C 43/52; A45D 34/00; A45D 33/24; B29C 43/02; B65D 43/22; B29L 31/00; B29K 105/00

(52) U.S. Cl. CPC A45D 40/222; B65D 43/22; B65D 43/164; B29C 43/52; A45D 34/00; B29C 43/021; A45D 33/24; B29C 43/027; A45D 2040/224; B29K 2105/253; B29L 2031/718

(57) ABSTRACT

Disclosed is a cosmetic having an impregnation member with a melted outside. The impregnation member (40) is inserted into a heated metal mold (50) formed with a concave and convex part and pressed such that upper and lower surfaces (41 and 42) of the impregnation member (40) are melted, thereby forming a concave and convex part on the upper surface (41) of the impregnation member (40) and forming a compressed layer on the lower surface (42) of the impregnation member (40), and the impregnation member (40) is impregnated with a cosmetic material.

### CROSS-REFERENCE TO RELATED APPLICATION

This application claims the benefit of Korean application No. 10-2016-0049473, filed on Apr. 22, 2016 with the Korean Intellectual Property Office, the disclosure of which is incorporated herein by reference.

### BACKGROUND

The present invention relates to a cosmetic having an impregnation member with a melted outside, and more particularly, to a cosmetic having an impregnation member with a melted outside, where an open cell structure of an upper surface of the impregnation member is melted so that the open cell structure is deformed into an open cell structure having a size of half or less. When the impregnating member is stuck with a puff to use the cosmetic material, the cosmetic material may be prevented from being excessively stuck and wasted and it is possible to effectively use cosmetics by evenly sticking cosmetics on a puff. In addition, the open cell structure of the lower surface 42 may be melted to be deformed into an open cell structure having a size of half or less and the cosmetic material may be discharged only through the pressed upper surface 41, so that the cosmetic material is prevented from being wasted.

Cosmetics refer to goods which are used for a human body in order to add charming of the human body and change the appearance of the human body to be brighter, or to maintain or enhance skin or hair in a healthy state by making the human body clean and beautiful, and have a minor effect on the human body.

In general, cosmetics are manufactured by mixing mutually different materials using an emulsifying agent such as a surface active agent, and the cosmetic materials may be classified into water-in-oil (W/O) emulsion type cosmetic material and oil-in-water (O/W) emulsion type cosmetic material according to the bonding structure between water-based material and oil-based material.

The water-in-oil emulsion type cosmetic material, which is obtained by bonding an oil-based material to an outside of water-based material, has a larger quantity of oil so that the absorption of skin is slow and the touch feeling is heavy, but the persistence is longer than that of the oil-in-water emulsion type cosmetic material. Thus, the cosmetics requiring persistence are manufactured by using the W/O emulsion type cosmetic material to increase water resistance against sweat and water.

The cosmetics are manufactured reduce the viscosity of content in order to compensate the defects of the W/O emulsion type cosmetic material that the touch feeling is heavy and sticky. However, when the water-in-oil product having low viscosity remains for a long time in circulation, the aqueous material of internal phase and the oil materials of external phase may be separated from each other. In this case, a user shakes a container to mix the separated aqueous and oil materials with each other for use, but it is inconvenient to shake the container for use.

To solve the problems described above, as shown in FIG. 1, a product, which disclosed an Korean Registered Patent No. 10-1159877 issued to the applicant the present application, has been developed, where an impregnation member 1 impregnated with water-in-oil contents having low viscosity is contained in compact container.

However, according to the above-described related art, since the contents are filled in the impregnating member 1 when the cosmetics are used for the first time, even when the pressure is applied with a small force, the contents are stuck on a puff more than necessary to be wasted.

### SUMMARY

To solve the problems described above, an object of the present invention is to provide a cosmetic having an impregnation member with a melted outside, where an open cell structure of an upper surface of the impregnation member is melted so that the open cell structure is deformed into an open cell structure having a size of half or less. When the impregnating member is stuck with a puff to use the cosmetic material, the cosmetic material may be prevented from being excessively stuck and wasted and it is possible to effectively use cosmetics by evenly sticking cosmetics on a puff. In addition, the open cell structure of the lower surface 42 may be melted to be deformed into an open cell structure having a size of half or less and the cosmetic material may be discharged only through the pressed upper surface 41, so that the cosmetic material is prevented from being wasted.

According to the present invention, there is provided a cosmetic having an impregnation member with a melted outside, which includes:

an outer container (10) having an upper part opened;

an outer container lid (20) coupled to one side of the outer container (10);

an inner container (30) installed into an inside of the outer container (10);

an impregnation member (40) installed in the inner container (30) and impregnated with a cosmetic material; and

an inner container lid (70) hinge-coupled to one side of the inner container (30) to be opened and closed,

wherein the impregnation member (40) is inserted into a heated metal mold (50) formed with a concave and convex part and pressed such that upper and lower surfaces (41 and 42) of the impregnation member (40) are melted, thereby forming a concave and convex part on the upper surface (41) of the impregnation member (40) and forming a compressed layer on the lower surface (42) of the impregnation member (40).

The cosmetic may further include a fixing member (60) coupled to an upper end of the inner container (30) to prevent the impregnation member (40) from being released to an outside.

The upper surface (41) of the impregnation member (40) is blockaded while being melted by the metal mold (50) and the blockaded upper surface (41) is perforated by a plurality of needles.

The concave and convex may be formed only on an edge of the upper the impregnation member (40).

The concave and convex part formed on the upper surface of the impregnation member (40) may have a convex-circle shape or a polygonal shape.

The impregnation member (40) may include a side surface (43) melted by a heat of the metal mold (50).

The cosmetic may further include a discharging net (80) coupled to the fixing member (60).

The cosmetic may further include a discharge net (80) formed on an upper surface of the fixing member (60).

According to the cosmetic having an impregnation member with a melted outside of present invention, the open cell structure of the upper surface of the impregnation member is melted so that the open cell structure is deformed into an open cell structure having a size of half or less. Thus, when the impregnating member is stuck with a puff to use the cosmetic material, the cosmetic material may be prevented from being excessively stuck and wasted and it is possible to effectively use cosmetics by evenly sticking cosmetics on a puff. In addition, the open cell structure of the lower surface 42 may be melted to be deformed into an open cell structure having a size of half or less and the cosmetic material may be discharged only through the pressed upper surface 41, so that the cosmetic material is prevented from being wasted.

### BRIEF DESCRIPTION OF THE DRAWINGS

FIG. 1 is a perspective view showing a compact container according to the related art.

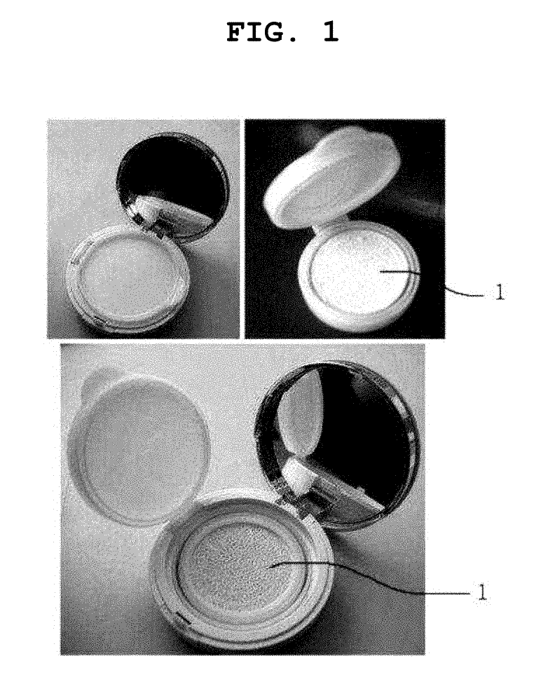

FIG. 2 is a perspective view showing a cosmetic having an impregnation member with a melted outside according to an embodiment or the present invention.

FIG. 3 is an exploded perspective view showing a cosmetic having an impregnation member with a melted outside according to an embodiment of the present invention.

FIG. 4 is a sectional view showing a cosmetic having an impregnation member with a melted outside according to an embodiment of present invention.

FIG. 5 is a perspective view showing a cosmetic having an impregnation member with a melted outside according to another embodiment of the present invention.

FIG. 6 is a sectional view showing a cosmetic having an impregnation member with a melted outside according to another embodiment of the present invention.

FIG. 7 is a sectional view showing a state in which an impregnation member contained in a cosmetic having an impregnation member with a melted outside is molded according to an embodiment of the present invention.

FIG. 8 is a sectional view showing a state in which an impregnation member contained in a cosmetic having an impregnation member with a melted outside is molded according to an embodiment of the present invention.

FIG. 9 is an exploded perspective view showing a cosmetic having an impregnation member with a melted outside according to still another embodiment of the present invention.

### DETAILED DESCRIPTION OF THE EMBODIMENTS

Hereinafter, a cosmetic having an impregnation member with a melted outside according to an embodiment of the present invention will be described with reference to accompanying drawings.

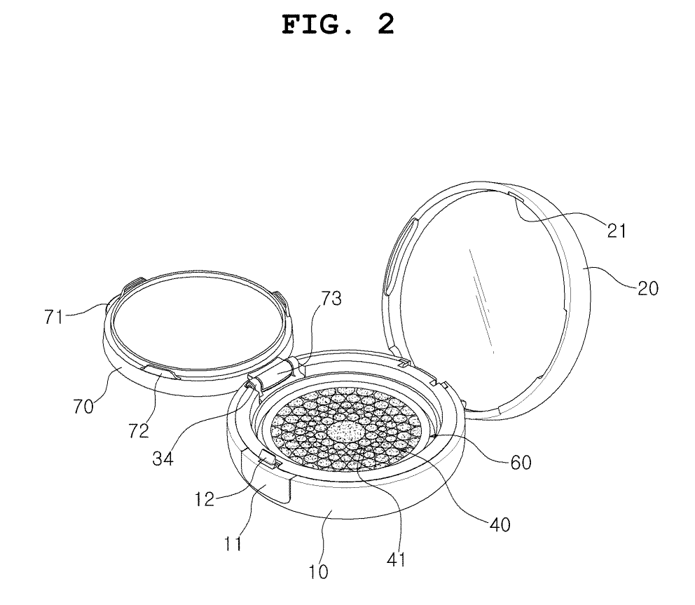

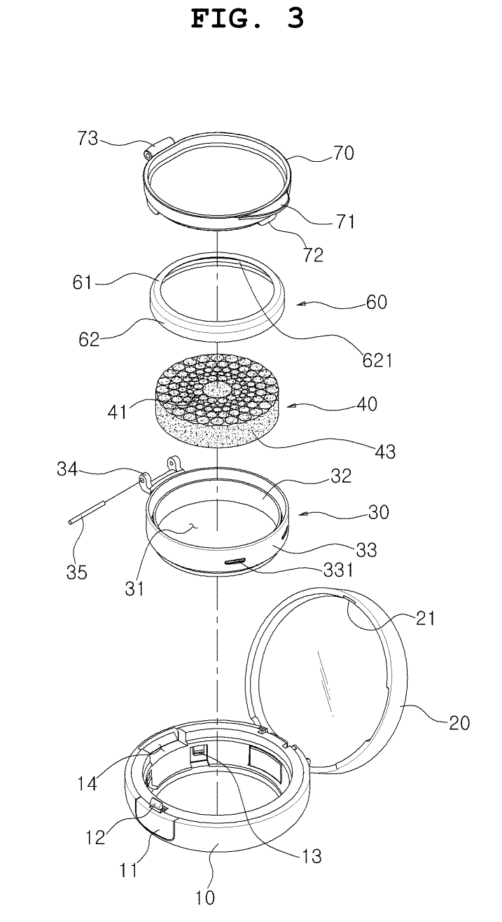

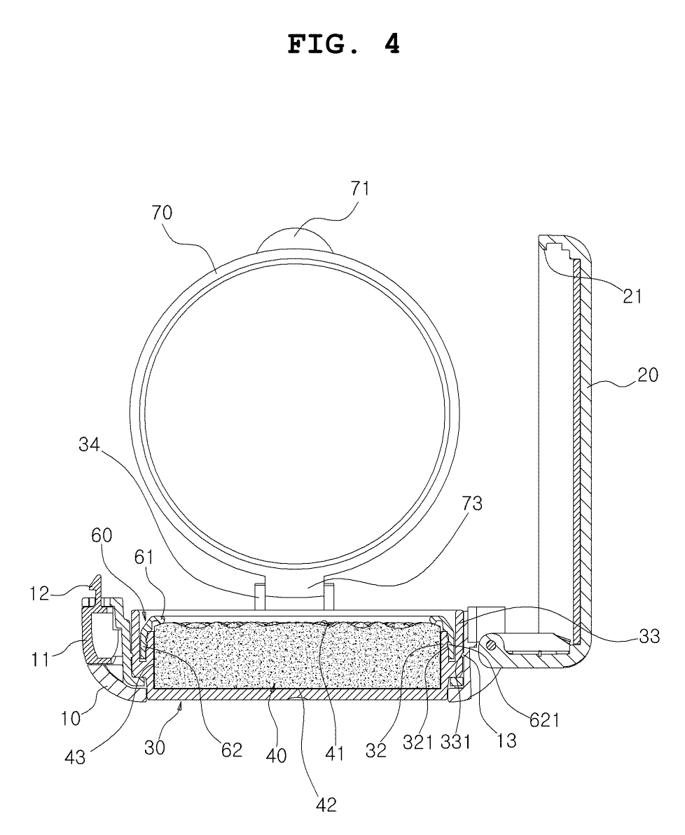

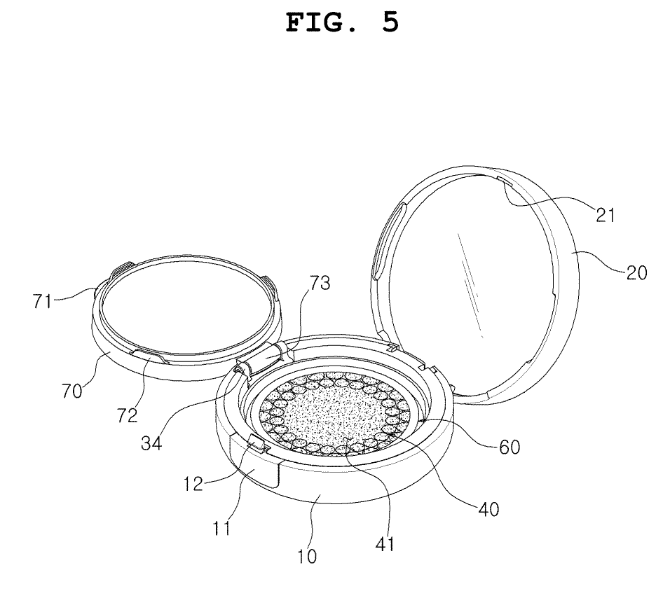

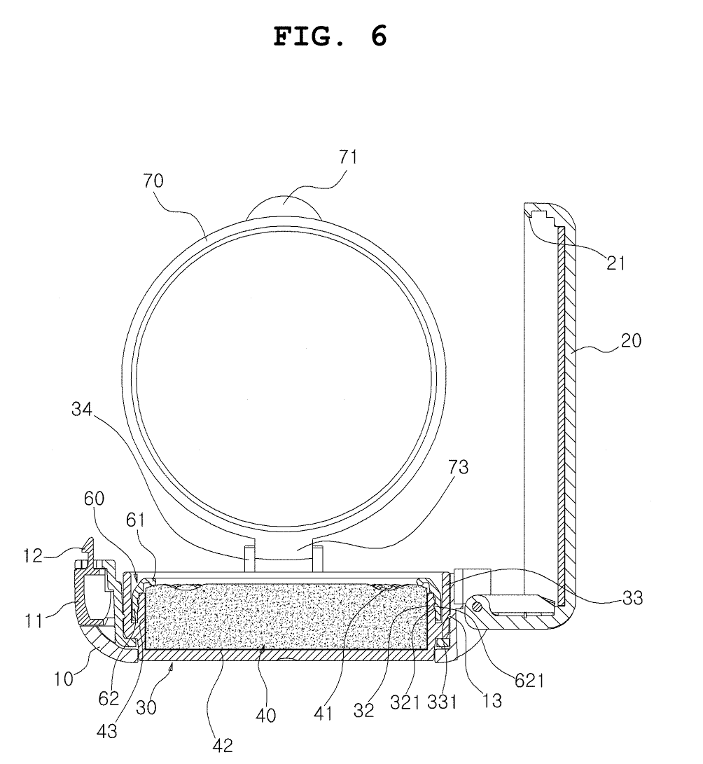

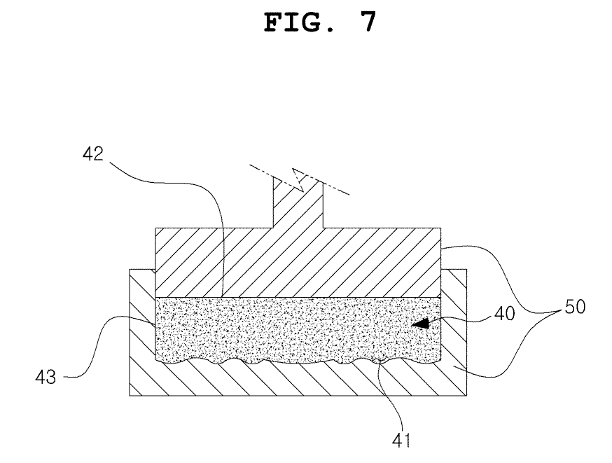

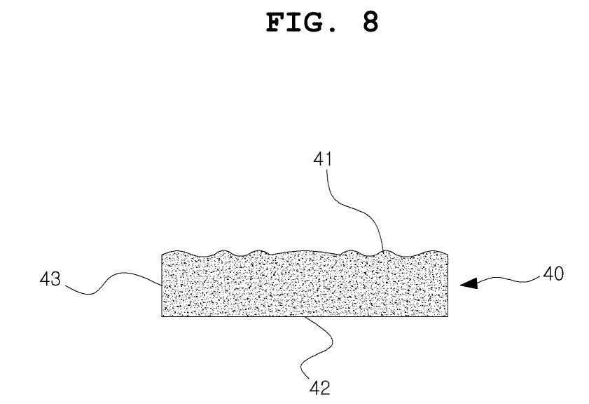

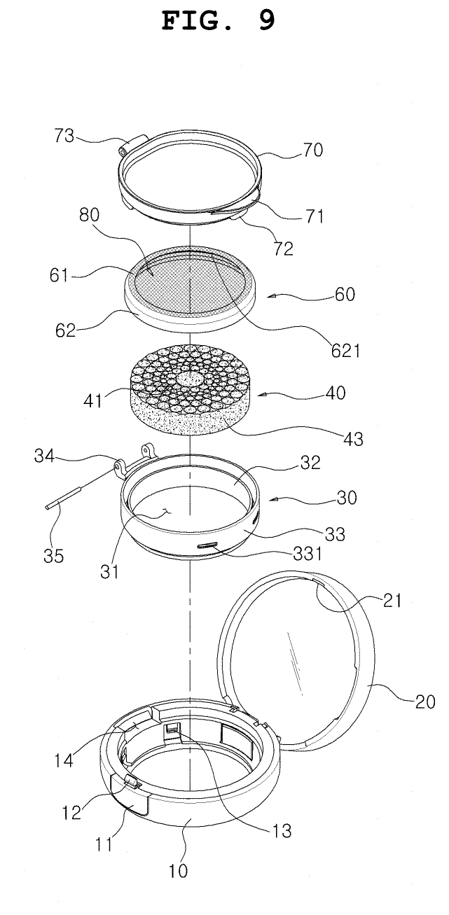

FIG. 2 is a perspective view showing a cosmetic having an impregnation member with a melted outside according to an embodiment of the present invention. FIG. 3 is an exploded perspective view showing a cosmetic having an impregnation member with a melted outside according to an embodiment of the present invention. FIG. 4 is a sectional view showing a cosmetic having an impregnation member with a melted outside according to an embodiment of the present invention. FIG. 5 is a perspective view showing a cosmetic having an impregnation member with a melted outside according to another embodiment of the present invention. FIG. 6 is a sectional view showing a cosmetic having an impregnation member with a melted outside according to another embodiment of the present invention. FIG. 7 is a sectional view showing a state in which an impregnation member contained in a cosmetic having an impregnation member with a melted outside is molded according to an embodiment of the present invention. FIG. 8 is a sectional view showing a state in which an impregnation member contained in a cosmetic having an impregnation member with a melted outside is molded according to an embodiment of the present invention. FIG. 9 is an exploded perspective view showing a cosmetic having an impregnation member with a melted outside according to still another embodiment of the present invention.

According to the present invention, there is provided a cosmetic having an impregnation member 40 with a melted outside. The impregnation member 40 is inserted into a heated metal mold 50 formed with a concave and convex part and pressed such that upper and lower surfaces 41 and 42 of the impregnation member 40 are melted, thereby forming a concave and convex part on the upper surface 41 of the impregnation member 40 and forming a compressed layer on the lower surface 42 of the impregnation member 40, and the impregnation member 40 is impregnated with a cosmetic material.

The cosmetic material impregnated into the impregnation member 40 may be a gel-type foundation containing an ultraviolet screening agent.

In addition, a cosmetic having an impregnation member 40 with a melted outside according to the present invention includes an outer container 10 having an upper part opened, an outer container lid 20 coupled to one side of the outer container 10, an inner container 30 installed into an inside of the outer container 10, an impregnation member 40 installed in the inner container 30 and impregnated with a cosmetic material, and an inner container lid 70 hinge-coupled to one side of the inner container 30 to be opened and closed. The impregnation member 40 is inserted into a heated metal mold 50 formed with a concave and convex part and pressed such that upper and lower surfaces 41 and 42 of the impregnation member 40 are melted, thereby forming a concave and convex part on the upper surface 41 of the impregnation member 40 and forming a compressed layer on the lower surface 42 of the impregnation member 40.

The outer container 10 has a push button 11 provided one side surface thereof with a locking sill protrusion 12 and a hinge formed on the opposite side of the push button 11, such that the outer container 10 is hinged to the outer container lid 20. In addition, the outer container 10 includes a coupling protrusion 13 formed on an inner circumferential surface thereof, and a hinge bracket installation groove 14 formed on an inner periphery thereof.

The locking sill 12 extending from an upper portion of push button 11 is easily retracted by a pushing operation of a user, such that the push button 11 is released from a locking protrusion 21 of the outer container lid 20.

The coupling protrusion 13 is coupled to a coupling groove 331 formed on an outer circumferential surface of an outer wall 33 of the inner container 30.

A hinge bracket 34 of the inner container 30 is inserted into the hinge bracket installation groove 14.

The outer container lid 20, which covers an upper portion of the outer container 10, is hinge-coupled to the outer container 10 such that the outer container lid 20 opens or closes the outer container 10.

The locking protrusion 21 formed at one side of the outer container lid 20 has a protrusion shape corresponding to the locking sill 12 of the outer container 10.

The inner container 30 is installed inside the outer container 10. The inner container 30 includes a bottom surface 31, an inner wall 32 extending upwardly from the bottom surface 31, and an outer wall 33 formed to be spaced part from an outside of the inner wall 32 by a predetermined interval.

A coupling protrusion 321 is formed on an outer circumferential surface of the inner wall 32, and is fitted into a coupling groove 621 formed on a fixing member 60, such that the fixing member 60 is prevented from being separated from the inner container 30.

The coupling groove 331 is formed on an outer circumferential surface of the outer wall 33. The coupling groove 331 is coupled with the coupling protrusion 13 formed on the inner circumferential surface of the outer container 10, such that the inner container 30 is prevented from being separated from the outer container 10.

The hinge bracket 34 is formed on the outer circumferential surface of the outer wall 33, and a hinge block 73 formed on the inner container lid 70 is hinge coupled to the hinge bracket 34.

The impregnation member 40 impregnated with a cosmetic material is embedded in the inner container 30. The impregnated member 40 includes at least one selected from the group consisting of butadiene rubber, styrene butadiene rubber, natural rubber, wet urethane, dry urethane, polyether, polyester, polyvinyl chloride, polyethylene, ethylene vinyl acetate, latex, silicon, styrene isoprene styrene, styrene ethylene butylene styrene, polyvinyl alcohol, silicone agent elastomer, nitrile rubber, butyl rubber and neoprene.

As shown in FIG. 7, the impregnation member 40 is melted by pressing the upper and lower surfaces 41 and 42 with a metal mold 50 which is heated and formed with a concave and convex part, such that the concave and convex part is formed on the upper surface 41 and the pressed layer is formed on the lower surface 42 as shown in FIG. 8.

An open cell structure of the upper surface 41 of the impregnation member 40, which is formed on the upper surface 41 with the concave and convex part, is melted to be deformed such that the size of the open cell structure is reduced half or less. Thus, the cosmetic material is thinly stuck on a puff, so that it is possible to effectively use the cosmetics.

The concave and convex part formed on the upper surface 41 of the impregnation member 40 is formed in a convex-circle or polygonal shape.

Since the upper surface 41 of the impregnation member 40 may be partially blockaded while the metal mold (50) is melted by heat, the blockaded upper surface 41 is pressed with a plurality of needles to be perforated, so that the cosmetic material impregnated into the impregnation member 40 may be smoothly discharged.

In addition, as shown in FIGS. 5 and 6, the concave and convex part may be formed by melting only on an edge of the upper surface 41 of the impregnation member 40.

As shown in FIG. 7, an open cell structure of the lower surface 42 is melted and deformed by the heat of the metal mold 50 so that a size of the open cell structure is reduce half or less.

Since the upper and lower surfaces 41 and 42 of the impregnation member 40 are melted by the heat, when the upper surface 41 is pressed, the contents impregnated into the impregnated member 40 are discharged only through the upper surface 41 to an outside.

Since the contents are not discharged through the lower surface 42, the contents are discharged only through the upper surface 41 pressed, so that the contents may be prevented from being wasted.

Like the upper surface 41, the lower surface 42 may also be formed with a concave and convex part.

The side surface 43 of the impregnation member 40 is also melted by the heat of the metal mold 50 to melt the open cell structure, so that the open cell structure is deformed into an open cell structure having a size of half or less. Thus, the contents impregnated into the impregnation member 40 are not discharged to the side surface 43.

The fixing member 60 is coupled to the inner container 30. The fixing member 60 includes a horizontal extension piece 61 extending inward and a lower extension piece 62 extending downward from the horizontal extension piece 61.

The horizontal extension piece 61 is safely placed on an upper end of the inner wall 32 of the inner container 30 to prevent the impregnation member 40 from being detached.

The lower extension piece 62 has an engagement groove 621 formed on an inner circumferential surface thereof and the engagement groove 621 is engaged with the engagement protrusion 321 formed on the outer peripheral surface of the inner wall 32 of the container 30, so that the fixing member 60 is prevented from being detached from the container 30.

In addition, as shown in FIG. 9, a discharging net 80 may be further coupled to the fixing member 60. The discharging net 80 may be separately formed on the upper surface of the fixing member 60.

The discharging net 80 may be separately formed at an inside of the inner container 30.

The discharging net 80 may more evenly discharges the cosmetic material impregnated into the impregnation member 40.

The discharging net 80 may be formed of synthetic resin, natural rubber, or metal.

An inner container lid 70 is coupled to one side of the inner container 30 to open and close the inner container 70.

A handle 71 is formed on one side of the inner container lid 70 and a sealing piece is formed on a lower end of the inner container lid 70. A hinge block 73 is formed on the opposite side of the handle 71.

The handle 71 allows the inner container lid 70 to be easily opened or closed.

The sealing piece 72 is fitted inside the outer wall 33 of the inner container 30 when the inner container lid 70 is closed to the inner container 30, so that the sealing of the inner container 30 is enhanced.

The hinge block 73 is fitted into the hinge bracket 34 of the inner container 30 and is then fixed by a hinge pin 35.

A method of assembling a cosmetic having an impregnating member with a melted outside and a use state according to an embodiment the present invention will be described in detail as follows.

The outer container lid 20 is coupled to the outer container 10 on which the push button 11 is formed in order to assemble the cosmetic having an impregnation member with a melted outside according to the present invention.

Then, the inner container lid 70 is coupled to the inner container 30.

The impregnation member 40 impregnated with a cosmetic material is installed into the inner container 30 coupled to the inner container lid 70. As shown in FIG. 7, the upper and lower surfaces 41 and 42 are pressed with the metal mold 50, in which the concave and convex part is formed and which is heated, to be melted, such that the concave and convex part is formed on the upper surface 41 and the compressed layer is formed on the lower surface 42.

The concave and convex part formed on the upper surface 41 of the impregnation member 40 may be formed in various sizes of a convex circle or polygonal shape.

In addition, as shown in FIGS. 5 and 6, only the edge of the upper surface 41 of the impregnation member 40 may be melted to form the concave and convex part.

Then, after the fixing member 60 is coupled to the inner container 30 in which the impregnation member 40 is installed, the inner container 30 is coupled inside the outer container 10 to complete the assembly.

The open cell structure of the upper surface 41 of the impregnation member 40 of the cosmetic having an impregnated member with a melt outside assembled in the above-described method is melted so that the open cell structure is deformed into an open cell structure having a size of half or less. When the impregnating member 40 is stuck with a puff to use the cosmetic material, the cosmetic material may be prevented from being excessively stuck and wasted and it is possible to effectively use cosmetics by evenly sticking cosmetics on a puff. In addition, the open cell structure of the lower surface 42 may be melted to be deformed into an open cell structure having a size of half or less and the cosmetic material may be discharged only through the pressed upper surface 41, so that the cosmetic material is prevented from being wasted.

The concave and convex part formed on the upper surface 41 of the impregnation member 40 is formed in various sizes of a convex circle or a polygonal shape, so that various designs may be implemented, thereby widening the choice of consumers.

As described above, the cosmetic having an impregnation member with a melted outside described in this disclosure is an illustrative purpose only, and the present invention is not limited thereto. Thus, it should be understood that numerous other modifications and embodiments can be devised by those skilled in the art within the spirit and scope of the present invention and they will fall within the scope of the present invention.

1. A cosmetic having an impregnation member with a melted outside,
wherein the impregnation member (40) is inserted into a heated metal mold (50) formed with a concave and convex part and pressed such that upper and lower surfaces (41 and 42) of the impregnation member (40) are melted, thereby forming a concave and convex part on the upper surface (41) of the impregnation member (40) and forming a compressed layer on the lower surface (42) of the impregnation member (40), and the impregnation member (40) is impregnated with a cosmetic material.

2. A cosmetic having an impregnation member with a melted outside, the cosmetic comprising:
an outer container (10) having an upper part opened;
an outer container lid (20) coupled to one side of the outer container (10);
an inner container (30) installed into an inside of the outer container (10);
an impregnation member (40) installed in the inner container (30) and impregnated with a cosmetic material; and
an inner container lid (70) hinge-coupled to one side of the inner container (30) to be opened and closed,
wherein the impregnation member (40) is inserted into a heated metal mold (50) formed with a concave and convex part and pressed such that upper and lower surfaces (41 and 42) of the impregnation member (40) are melted, thereby forming a concave and convex part on the upper surface (41) of the impregnation member (40) and forming a compressed layer on the lower surface (42) of the impregnation member (40).

3. A cosmetic having an impregnation member with a melted outside, the cosmetic comprising:
an inner container (30);
an impregnation member (40) installed in the inner container (30) and impregnated with a cosmetic material; and
an inner container lid (70) hinge-coupled to one side of the inner container (30) to be opened and closed,
wherein the impregnation member (40) is inserted into a heated metal mold (50) formed with a concave and convex part and pressed such that upper and lower surfaces (41 and 42) of the impregnation member (40) are melted, thereby forming a concave and convex part on the upper surface (41) of the impregnation member (40) and forming a compressed layer on the lower surface (42) of the impregnation member (40).

4. The cosmetic of claim 3, further comprising a fixing member (60) coupled to an upper end of the inner container (30) to prevent the impregnation member (40) from being released to an outside.

5. The cosmetic of claim 3, wherein the upper surface (41) of the impregnation member (40) is blockaded while being melted by the metal mold (50) and the blockaded upper surface (41) is perforated by a plurality of needles.

6. The cosmetic of claim 3, wherein the concave and convex part is formed only on an edge of the upper surface (41) of the impregnation member (40).

7. The cosmetic of claim 3, wherein the concave and convex part formed on the upper surface (41) of the impregnation member (40) has a convex-circle shape or a polygonal shape.

8. The cosmetic of claim 3, wherein the impregnation member (40) includes a side surface (43) melted by a heat of the metal mold (50).

9. The cosmetic of claim 4, further comprising a discharging net (80) coupled to the fixing member (60).

10. The cosmetic of claim 4, further comprising a discharge net (80) formed on an upper surface of the fixing member (60).

11. The cosmetic of claim 3, further comprising a separate discharge net (80) formed inside the inner container (30).

12. The cosmetic of claim 2, further comprising a fixing member (60) coupled to an upper end of the inner container (30) to prevent the impregnation member (40) from being released to an outside.

13. The cosmetic of claim 2, wherein the upper surface (41) of the impregnation member (40) is blockaded while being melted by the metal mold (50) and the blockaded upper surface (41) is perforated by a plurality of needles.

14. The cosmetic of claim 1, wherein the upper surface (41) of the impregnation member (40) is blockaded while being melted by the metal mold (50) and the blockaded upper surface (41) is perforated by a plurality of needles.

15. The cosmetic of claim 2, wherein the concave and convex part is formed only on an edge of the upper surface (41) of the impregnation member (40).

16. The cosmetic of claim 1, wherein the concave and convex part is formed only on an edge of the upper surface (41) of the impregnation member (40).

17. The cosmetic of claim 2, wherein the concave and convex part formed on the upper surface (41) of the impregnation member (40) has a convex-circle shape or a polygonal shape.

18. The cosmetic of claim 1, wherein the concave and convex part formed on the upper surface (41) of the impregnation member (40) has a convex-circle shape or a polygonal shape.

19. The cosmetic of claim 2, wherein the impregnation member (40) includes a side surface (43) melted by a heat of the metal mold (50).

20. The cosmetic of claim 1, wherein the impregnation member (40) includes a side surface (43) melted by a heat of the metal mold (50).

21. The cosmetic of claim 12, further comprising a discharging net (80) coupled to the fixing member (60).

22. The cosmetic of claim 12, further comprising a discharge net (80) formed on an upper surface of the fixing member (60).

23. The cosmetic of claim 2, further comprising a separate discharge net (80) formed inside the inner container (30).

24. The cosmetic of claim 1, further comprising a separate discharge net (80) formed inside the inner container (30).
